(19) United States
(12) Patent Application Publication
(10) Pub. No.: US 2007/0295436 A1
(43) Pub. Date: Dec. 27, 2007

(54) PRESSURE APPLICATION SYSTEM FOR ADHESIVE MOUNTED ARTICLES

(76) Inventor: Mark Joseph, Aspen, CO (US)

Correspondence Address: GLENN L. WEBB;GLENN L. WEBB P.C., P.O BOX 951, CONIFER, CO, 80433, US

(21) Appl. No.: 11/426,574

(22) Filed: Jun. 26, 2006

(51) Int. Cl. B32B 37/12; B32B 7/12

(52) U.S. Cl. 156/60; 428/343; 156/579

(57) ABSTRACT

An adhesive mounting system. The adhesive mounting system enables a stronger mounting between the mounted object, adhesive and a mounting surface. The system uses an applicator to greatly increase the pressure applied on the adhesive against the mounting surface. This increases the bonding of the adhesive and the mounting surface. Further, the adhesive is forced into contact with uneven surfaces to increase the bonding area. The applicator in one embodiment includes a reduced end portion to increase the application pressure.

### FIELD OF THE INVENTION

This invention relates to the field of adhesive mounted articles.

### BACKGROUND OF THE INVENTION

The use of pressure sensitive adhesives for mounting articles to walls, ceilings, cabinets or other surfaces have become very popular. These adhesives are used for mounting such articles as hooks, picture hanging hardware, clocks, decorating clips, bathroom accessories, and many other types of articles. These adhesives may be already affixed onto the mounting surface of an article or may be supplied as double sided strips. Some products have adhesive surfaces that may be affixed onto a mounting plaque that then has the article mounted onto the plaque.

These adhesives include weak bonding adhesive for temporary installations, similar to masking tape, strong bonding adhesives that are nearly permanent and releasable adhesives such as the Command series of adhesive strips and articles by 3M. Most of these adhesives are double sided with a soft foam or elastomeric base layer. This foam layer improves adhesion because it allows the adhesive surfaces to conform to uneven textured surfaces and allows the adhesive to contact both the peaks and valleys of the texture. When the item is loaded, the foam layer spreads the force more evenly to increase strength.

Regardless of the type of adhesive, there are common problems with all of these articles. These articles tend to work best for small and light uses such as hooks or clips that are not designed to carry a significant load. While the adhesives are capable of creating a strong bond between the article and the mounting surface, existing products often don't achieve the designed high strength bond particularly on textured surfaces. This is due to a lack of adequate pressure applied to the adhesive surface against the mounting surface during installation. Many products using adhesive application limit the amount of adhesive tape to one or two square inches and less than five pound loads. These items are capable of adhering properly when pushed onto the mounting surface with normal hand pressure.

Items that need to carry heavier loads often have more square inches of adhesive to support the heavier loads but fail to adequately adhere properly in a dependable manner. This is primarily due to the lack of pressure that is applied to the adhesive surface area since application pressure by the hand is limited. The typical mounting process using an adhesive backed article is to simply press the article against the mounting surface momentarily. A typical adhesive mounting surface for a mounting plaque might be two square inches. If the person applying the pressure exerts 20 pounds, then the mounting pressure is 10 pounds of force per square inch. This is minimally enough pressure to make adequate adhesion to a smooth surface and often not quite enough to adhere adequately to a textured surface. It should be noted that the soft foam layer of the adhesive must be compressed hard enough to cause it to conform to textured surfaces and contact both the peaks and valleys of the texture for a complete bond. Soft foams tend to be weaker and require less pressure to conform. Harder foams are stronger and require more pressure. The harder the foam, the more pressure required

This problem is exacerbated even more as larger adhesive surfaces are used. The amount of force that a person may individually apply with their hand to a wall or ceiling is typically in the ten to twenty pounds range. As the area of adhesive surface is increased, the actual pressure exerted on the adhesive surface against the mounting surface is decreased exponentially. For example, applying 20 pounds of pressure to a plaque that has 8 square inches of adhesive results in only about 2.5 pounds of pressure applied per square inch. This is not adequate pressure in many applications for the adhesive to adequately bond to the mounting surface. This pressure may vary if the person pushes on the plaque and some areas receive more pressure and others receive less. Thus, as the surface area increases, the load bearing ability may actually be significantly decreased because inadequate pressure is applied to the adhesive or pressure is applied in an uneven manner.

Another problem occurs when a mounted item has more adhesive area and larger loads are applied. As load force is applied to the item that is unevenly adhered to a surface, point loading often occurs which applies far greater load to some areas and less to others. This point loading can start the adhesive to peel in the highly loaded area causing the item to delaminate. In addition, the point loading can cause the paint, drywall, wallpaper or other layers in the mounting surface to peel causing failure. Just increasing surface area of adhesives may not increase the holding power of the devise unless a mechanism is used to evenly spread the load over the entire adhesive surface and avoid point loading.

Presently, there is a problem with the many adhesive backed articles not adequately supporting their designed load and there are few adhesive articles that adequately support heavier loads.

### SUMMARY OF THE INVENTION

The present invention solves these and other problems by providing a unique adhesive mounting system for attachment onto mounting surfaces. The adhesive mounting system of the present invention enables a stronger mounting between the adhesive and a mounting surface.

The system of a preferred embodiment uses an applicator to greatly increase the pressure applied on the adhesive against the mounting surface. This increases the bonding of the adhesive and the mounting surface. Further, the adhesive is forced into contact with uneven surfaces to increase the bonding area. The applicator may be a knife edge applicator, roller applicator or other types of applicators.

The system of a preferred embodiment also uses a load bearing rigid frame designed to distribute load evenly to the entire flexible surface that the adhesive is mounted to.

This system may be used with any object suitable for mounting onto a surface with adhesives. This can include picture hangers, wall mounted accessories, hooks, picture hanging hardware, clocks, decorating clips, shelves, lighting, bathroom accessories, and many other types of articles. The system could also be used in many types of industry to assemble items using adhesives such as automotive, aerospace, furniture, pre-fabricated homes, recreational vehicles and many other uses.

The system of a preferred embodiment of the present invention uses an applicator tool to magnify the user force on the adhesive against the mounting surface. The applicator has a reduced contact area, such as a blunt knife edge, putty knife or radiused edge. The applicator could also have a wheel mounted to it that rolls along to apply pressure with less friction. The user force is applied through the applicator against a thin flexible area suspended in a frame of the object being mounted. This greatly increases the application force on the adhesive against the mounting surface. For example, if the applicator tool has a contact area of ⅛ inch, the force generated by a user applying 20 pounds of pressure is 160 pounds per square inch, many times greater than can be applied without the applicator. This increased force provides three benefits. First, the bonding pressure between the adhesive and the mounting surface is increased. Second, the adhesive is forced into uneven surfaces to increase the bonding area. Third, the load carried by the object that is mounted is spread over the increased bonding area to reduce point loading on the adhered surfaces.

The system of a preferred embodiment uses a frame having at least one flexible portion. The adhesive is affixed to the rear surface of the flexible portion. The applicator is pressed against the flexible portion to apply high pressure against the adhesive onto the mounting surface to ensure that the adhesive is applied evenly and with adequate force, especially on uneven surfaces.

The preferred embodiment of the present invention uses a frame having a rigid framework structure with the flexible adhesive bearing areas suspended between, much like the skin of a drum. The rigid structure ensures that a heavy load can be supported and spread evenly over the entire adhesive and mounting surface. The flexible portion allows the applicator tool to apply high point pressure as it is rubbed along the thin flexible surface.

The system of a preferred embodiment may also use releasable adhesives. The releasable adhesive enables the system to be removed without damage to the mounting surface.

The system of a preferred embodiment may also use a release mechanism that will mechanically remove the adhesive from the mounting surface without damage to the mounting surface. One example of this embodiment is the use of thread mounted to the fixture that cuts the adhesive from the mounting surface.

The system of a preferred embodiment may also have flexible elements, hinges or thinner areas to allow the rigid framework to adapt to curved surfaces, angled corners or uneven surfaces.

These and other features of the present invention will be evident from the ensuing detailed description of embodiments along with the drawings.

### BRIEF DESCRIPTION OF THE DRAWINGS

FIG. 1 is a perspective view of a preferred embodiment of a fixture utilizing the adhesive mounting system of the present invention.

FIG. 2 is the rear perspective view of the embodiment of FIG. 1.

FIG. 3 is a rear perspective view of the embodiment of FIG. 1 with adhesive mounting strips.

FIG. 4 is a side view of the embodiment of FIG. 1 with the applicator.

FIG. 5 is a perspective view of application of the embodiment of FIG. 1.

FIG. 6 is another perspective view of the application of the embodiment of FIG. 1.

FIG. 7 is a perspective view of the embodiment of FIG. 1 supporting a picture where the picture is shown as transparent.

FIG. 8 is a perspective view of an alternative embodiment of the applicator of a preferred embodiment of the present invention.

FIG. 9 is a perspective view of another alternative embodiment of the applicator of a preferred embodiment of the present invention.

FIG. 10 is a perspective exploded view of another fixture using the adhesive mounting system of the present invention.

FIG. 11 is a front perspective view of another fixture using the adhesive mounting system of a preferred embodiment of the present invention.

FIG. 12 is a side cutaway view of the fixture of FIG. 11.

FIG. 13 is a front perspective view of a interlocking component of a preferred embodiment of the present invention.

FIG. 14 is a front perspective view of a second interlocking component of the preferred embodiment of FIG. 13.

FIG. 15 is a side cutaway view of the assembled components of FIGS. 13 and 14.

FIG. 16 is a rear perspective view of the thread release mechanism of a preferred embodiment of the present invention.

FIG. 17 is a front perspective view of the thread release mechanism of FIG. 9.

FIG. 18 is a rear view of the thread release mechanism in operation.

FIG. 19 is a front perspective view of the adhesive mounting system using a releasable adhesive system.

FIG. 20 is a rear perspective view of the system of FIG. 12.

FIG. 21 is a front view of the system of FIG. 12 being applied to a mounting surface.

FIG. 22 is another view of the system of FIG. 12 being applied to a mounting system.

FIG. 23 is a rear perspective view of the system of FIG. 12 holding a picture.

FIG. 24 is a view of the system of FIG. 12 being removed.

FIG. 25 is a view of the system of FIG. 12 during the removal process.

FIG. 26 is a view of the adhesive mounting system of the present invention showing a thinned flexible portion.

FIG. 27 is a perspective view of the system of FIG. 26.

FIG. 28 is a perspective view of the system of FIG. 26.

FIG. 29 is another perspective view of the system of FIG. 26.

### DETAILED DESCRIPTION OF PREFERRED EMBODIMENTS

The present invention provides systems and methods for applying adhesive backed articles to mounting surfaces. It is to be expressly understood that the descriptive embodiments set forth herein are intended for explanatory purposes and is not intended to unduly limit the scope of the claimed inventions. Other embodiments and applications not described herein are considered to be within the scope of the invention. It is also to be expressly understood that while specific embodiments for the adhesive backed articles are discussed, other equivalents to these embodiments that perform substantially similar functions are within the scope of the claimed inventions.

The present invention enables a user to greatly increase the actual pressure on the adhesive mounting surface during the application of an adhesive backed article to a mounting surface. The present invention enables the pressure to be increased by providing a unique tool used with indentations in the article. The tool may also be used without the indentations as well. The frame with indentations may also be used without the tool. The force by the user is magnified by decreasing the surface area to which the force is applied. The load applied to the mounted frame is disbursed to the adhesive in a more even fashion with less point loading.

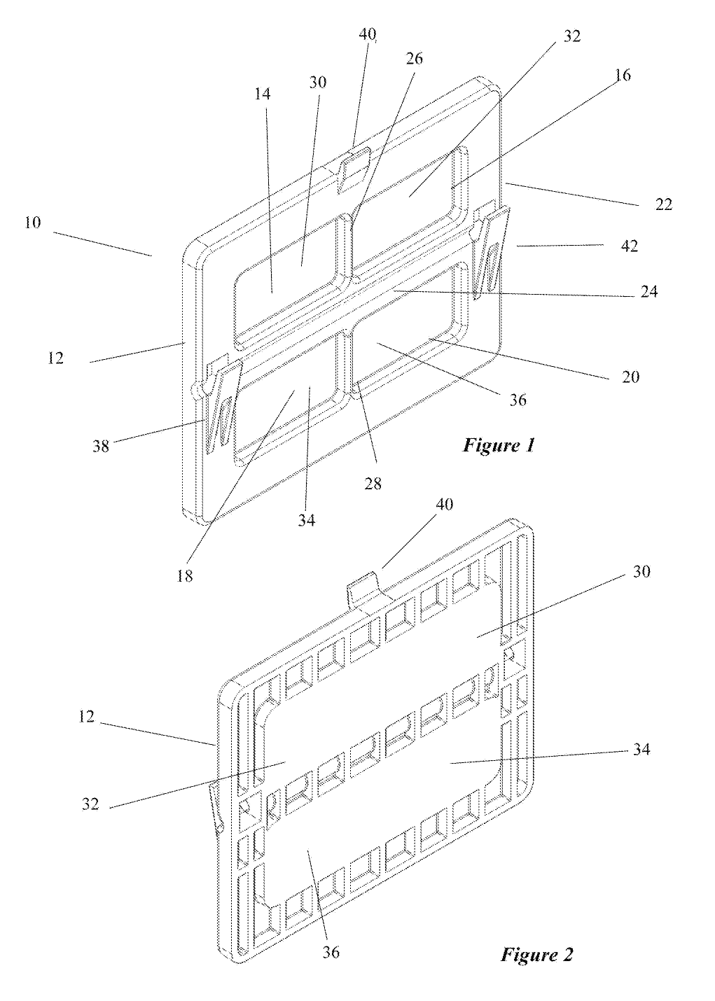

A preferred embodiment of the present invention is illustrated in FIGS. 1-6. This particular descriptive embodiment 10 is a hanger for heavy pictures. It is to be expressly understood that this is for descriptive purposes only and the claimed inventions cover many other embodiments as well. The picture hanger 10 includes frame 12 formed from a rigid material such as plastic or other materials. The frame 12 includes recessed sections 14, 16, 18, 20. The outer framework 22, cross-member 24 and ribs 26, 28 are sufficiently stiff and strong to support the load of the picture or other items after mounting. The bottom portions 30, 32, 34, 36 of the recessed sections shown in FIGS. 1 and 2 are thinner and more flexible in comparison with the outer framework, cross-member and ribs. Clips 38, 40, 42 are formed on the outer surface of the frame 12 to engage the picture support wire.

An adhesive material is affixed to the rear surface of the frame 12 on the rear side of the bottom portions 30, 32, 34, 36. This adhesive material may be an adhesive tape, an adhesive applied directly onto the surfaces or any other type of adhesive material. Most of these adhesives are double sided with a soft foam or elastomeric base layer. This foam layer improves adhesion because it allows the adhesive surfaces to conform to uneven textured surfaces and allows the adhesive to contact both the peaks and valleys of the texture. The foam layer may be a soft foam or a hard foam capable of supporting greater loads. An elastomeric material may be used as well to provide a strong substrate for supporting high loads.

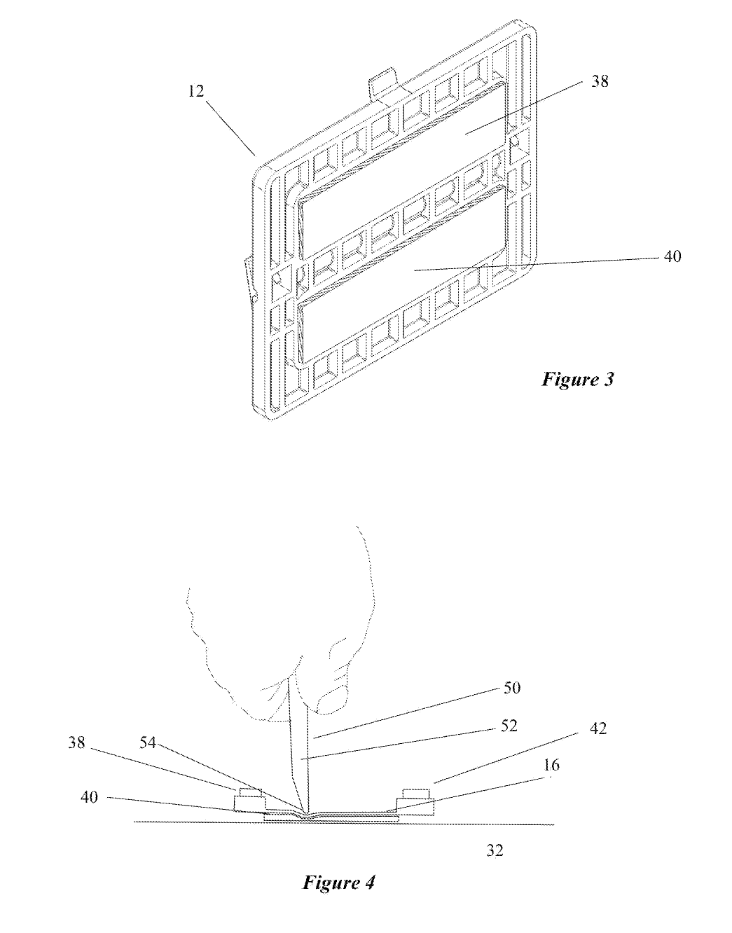

The adhesive strips 44, 46 have moderate adhesive properties that are able to be used for mounting on most surfaces but are then able to be removed without significant damage to the mounting surface. The adhesive mounting strips 44, 46, as shown in FIGS. 3 and 4, are mounted onto the rear side of the bottom portions 30, 32, 34, 36. It is to be expressly understood that other types of adhesive mounting materials can be used as well. The adhesive mounting strips will typically have a release liner that is removed before the hanger is mounted to a surface.

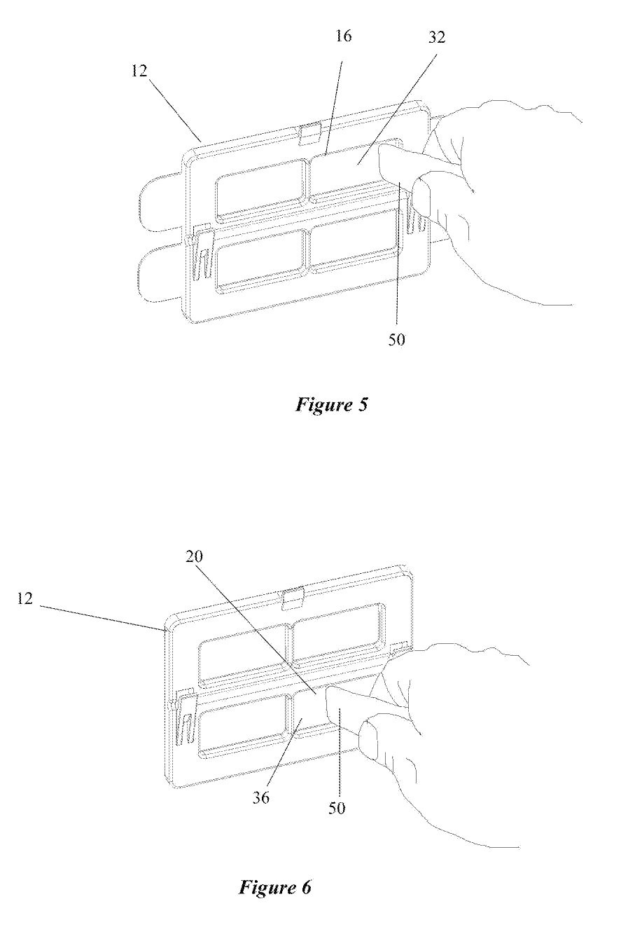

The system 10 of a preferred embodiment also includes an applicator 50. The applicator 50, shown in FIGS. 4-7 is a substantially flat stick shaped member that has a width about the same width as the recessed sections 14, 16, 18, 20. The end portion 52 of the applicator tapers down into a blunt knife edge 54, as shown in FIG. 4-5. In this particular embodiment, the width of the applicator is three quarters of an inch and the thickness of the blunt knife edge 54 is one sixteenth of an inch. It is to be expressly understood that the width of the applicator and the thickness of the blunt knife edge can be any dimension depending upon the system being mounted. The applicator 50 is formed of substantially rigid material, preferably of plastic, wood or other suitable material and has an enlarged rounded rear portion that fits the palm of the hand to comfortably bear a high load in a similar manner to a putty knife.

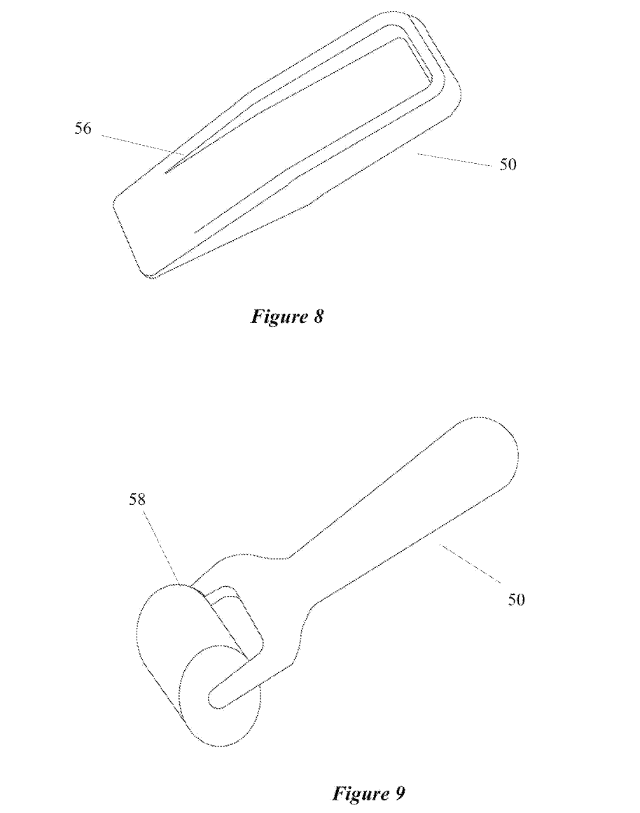

Another preferred embodiment of the applicator is illustrated in FIG. 8. This applicator 56 includes a reinforced portion to enable the user to apply increased force with the palm of the user on the applicator without the applicator flexing.

In another preferred embodiment shown in FIG. 9, the applicator uses a rolling member 58 instead of the knife edge. The rolling member is able to apply substantial pressure in much the same way as the knife edge with reduced friction.

In use, the release liners of the adhesive mounting strips 44, 46 are removed and the frame pressed against the mounting surface, such as a wall or any other desired surface where it sticks in a preliminary fashion. The blunt knife edge 54 of the applicator 50 is then inserted into the recessed portion 14 against the bottom portion 30. Pressure is applied by the user on the applicator 50 so that the blunt knife edge presses against the thin flexible bottom portion 38 to apply bonding pressure on the adhesive mounting strip 38. The pressure on the adhesive against the mounting surface is magnified by the use of the applicator. The applicator of this embodiment has an effective pressure application area of ¾ inch multiplied by one-sixteenth inch which equals 0.0437 square inches. If the user applies twenty pounds of force to the applicator, the applicator 50 applies four hundred and fifty seven pounds of force per square inch. A user applying the same twenty pounds of force to a five inch by five inch prior art hanger is only applying about eight tenths of a pound of force per square inch. Thus the applicator 50 of this preferred embodiment is magnifying the same pressure from the user by a factor of five hundred and seventy.

The user then simply moves the applicator 50 back and forth a few times along the length of the recessed portion 14. As shown in FIG. 5, the flexible bottom portion enables the adhesive mounting surface to flex into uneven surfaces. This process is repeated in each of the recessed sections 16, 18, 20. While the applicator of this preferred embodiment is substantially the same width as the recessed sections, a lesser width can be used with the user simply using the applicator in repeated motions to ensure that pressure is equally applied on all portions of the recessed bottom sections.

The magnified pressure applied to the adhesive mounting strips against the mounting surface provides at least three important benefits. First, the greatly increased pressure of the adhesive mounting strips against the mounting surface improves the adhesion between the strips and the mounting surface. This enables the hanger to support a greater load without fear of unintentional delamination of the hanger from the mounting surface. The rigid framework with the thinned portions on the frame 12 also is able to safely support much greater loads than previous hangers. The second benefit of the magnified force from the applicator 50 is the adhesive from the adhesive mounting strips is forced into uneven surfaces. Most mounting surfaces are not perfectly flat, particularly walls. These surfaces may be textured, uneven or otherwise not flat. The adhesive of the prior art hanger systems tends to contact the higher surfaces, thus decreasing the actual mounting surface that supports the load. The additional pressure from the use of the applicator combined with the thin flexible portion of the frame ensures that the adhesive is forced into the low valleys of the uneven surfaces to increase the adhesion surface. This spreads the load over a greater surface area, thus decreasing the amount of load per square inch on the adhesion between the hanger and the mounting surface. This reduces the tendency of the paint, wallpaper, drywall, other surface coatings, or surfaces to peel away from the wall or to delaminate. A third benefit is the elimination of point loading. The load carried by the object that is mounted is spread over the increased bonding area to reduce point loading on the adhered surfaces. Prior art products, when inadequately pressed during mounting, can have some points where the adhesive is connected to the mounting surface and other points where it is not. This can create points of high loading which will more likely cause the adhesion to peel or layers of paint to delaminate.

The rigid frame 12 spreads the load evenly and uniformly among all four of the adhesive mounting strips. The rigid frame also minimizes any deformation of the flexible bottom portions much as a drum frame allows the drum skins to flex but not deform.

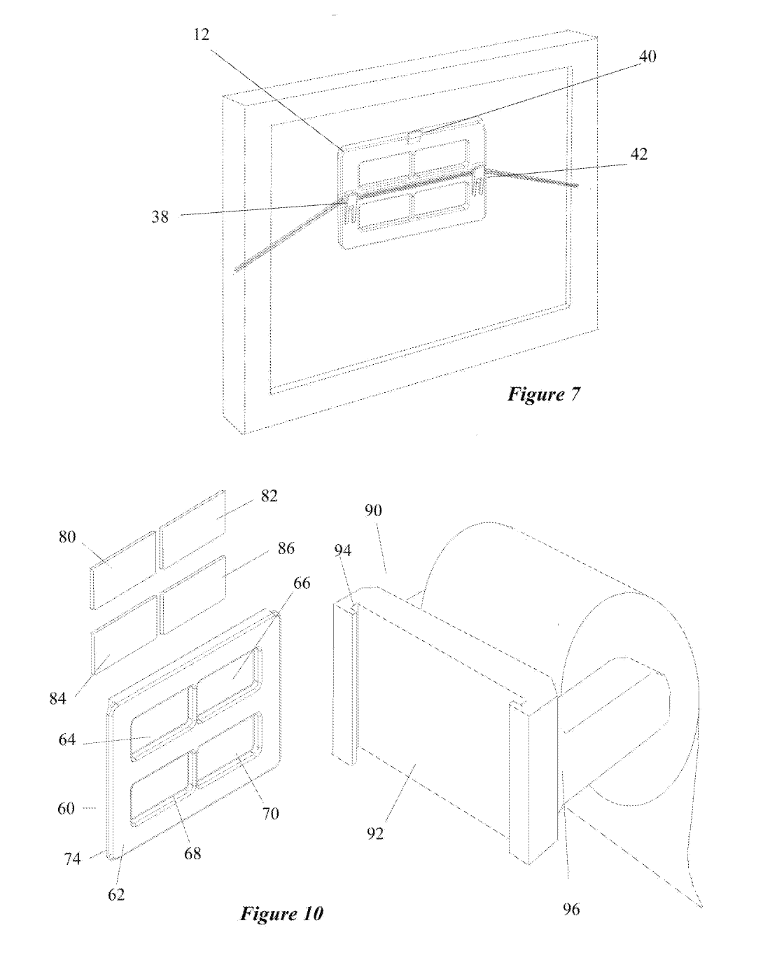

Some adhesives require a minimum time period for bonding before a load is applied. Once the bonding process has completed, then a picture or other object may be mounted on the clips 38, 40, 42 as shown in FIG. 7. The hanger system 10 of this preferred embodiment can easily support a substantial load depending on the type of adhesive, the mounting surface and the size of the frame 12.

The above embodiment describes a hanger system for pictures and other objects. The claimed invention also covers many other types of systems for attaching articles to a surface through adhesives. For example and without limitation, items such as hooks, picture hanging hardware, clocks, decorating clips, bathroom accessories, and many other types of articles. Also, the system may use a plaque for attaching sconces, towel bars, shelves or other decorative items.

One such plaque system is illustrated in FIG. 10. This system uses a plaque 60 having a rigid frame 62 with flexible thinner portions 64, 66, 68, 70. The frame 62 has an overextending edge 74. Adhesive strips 80, 82, 84, 85 are attached to the rear of the frame 62. The plaque is applied to a mounting surface in the manner described above using applicator 50. Once the plaque is firmly mounted on the mounting surface, a fixture 90, such as a toilet paper hanger 96 is then mounted over the plaque. The overextending edge 74 slides within the slot 94 on the fixture 90 to secure the fixture on the plaque. The surface 92 on the fixture 90 hides the frame 60 from view. Many means can be used to attach items to the frame including slots, snaps, screws, slide pins or other existing connection means

Industrial uses are limitless but may include attachment of automotive parts, prefabricated housing assembly, recreational vehicle construction, aerospace applications and many others. The plaque may simply be a frame such as frame 12 described above but without the clips. The plaque frame is applied to the mounting surface in a similar manner as the frame 12 is applied as described above. Once the plaque frame has securely bonded to the mounting surface, the functional article is attached onto the plaque frame by slot and hook engagement, snap engagement or by screws or other attachment mechanisms. In addition, the frame with the thinned portions may simply be made as part of an item so this mounting system can be used to join two or more parts together using the applicator to increase mounting pressure and the frame with thinned area to bear load and allow the applicator to perform it's function.

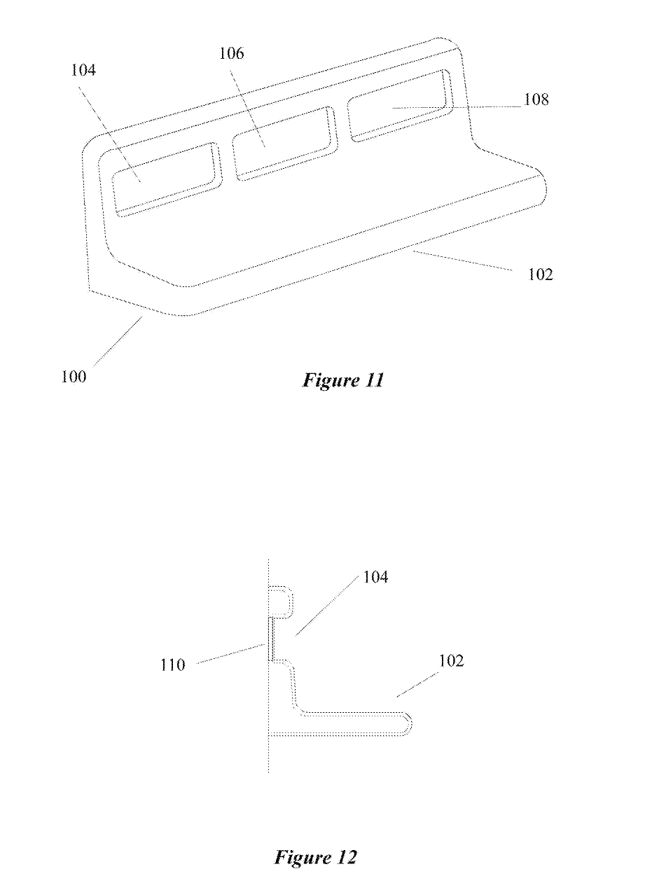

Another example of an embodiment of the present invention is illustrated in FIGS. 11 and 12. This example includes a shelf fixture 100 having a shelf portion 102 with thinned areas 104, 106, 108. Adhesive strips 110 are mounted on the rear side of the thinned areas 104, 106, 108. Shelf 100 is simply placed against the mounting surface and force is applied through the use of the applicator 50 so that increased pressure is applied between the adhesive strips 110 and the mounting surface.

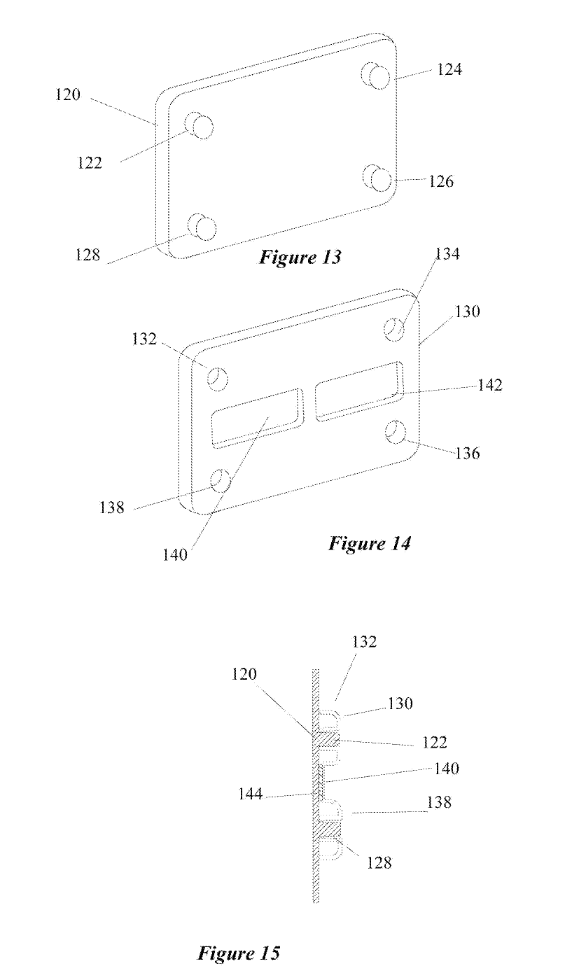

Other industrial uses include fastening two components to one another. For example, a molded frame with thin drum like sections may be adhered to thin sheets of material, such as aluminum, sheet metal, plastic, corrugated foam board, cardboard or any other material, may be fastened together with adhesive strips using the present invention. The frame may also be adhered to another molded part. These two parts may have mechanical interlocking features that are held together by adhesive applied to the thinned areas and the applicator can be used to form a strong bond. An example of this embodiment is illustrated in FIGS. 13-15. The first component 120 includes stubs 122, 124, 126, 128. The second component 130 includes four mating holes 132, 134, 136, 138 and thinned areas 140, 142. It is to be expressly understood that any shape and number of interlocking features may be used. Adhesive strips 144 are placed behind the thinned areas. The two components are snapped together so that the interlocking stubs 122, 124, 126, 128 engage in holes 132, 134, 136, 138, respectively. Pressure is applied through the thinned areas 124, 126, 128 to the adhesive strips 144 and component 120 through the use of an applicator. The mechanical interlocking nature of the parts can be used to increase the strength of the connection or bear specified loads better than adhesive alone. This use could provide fast and efficient assembly of otherwise difficult to assemble parts. The use of the applicator system enables greater adhesion between the adhesive and the surfaces of the materials to enable stronger and more secure fastening than previous adhesive fastening. This system may also be used in assembling and securing almost any other type of components as well.

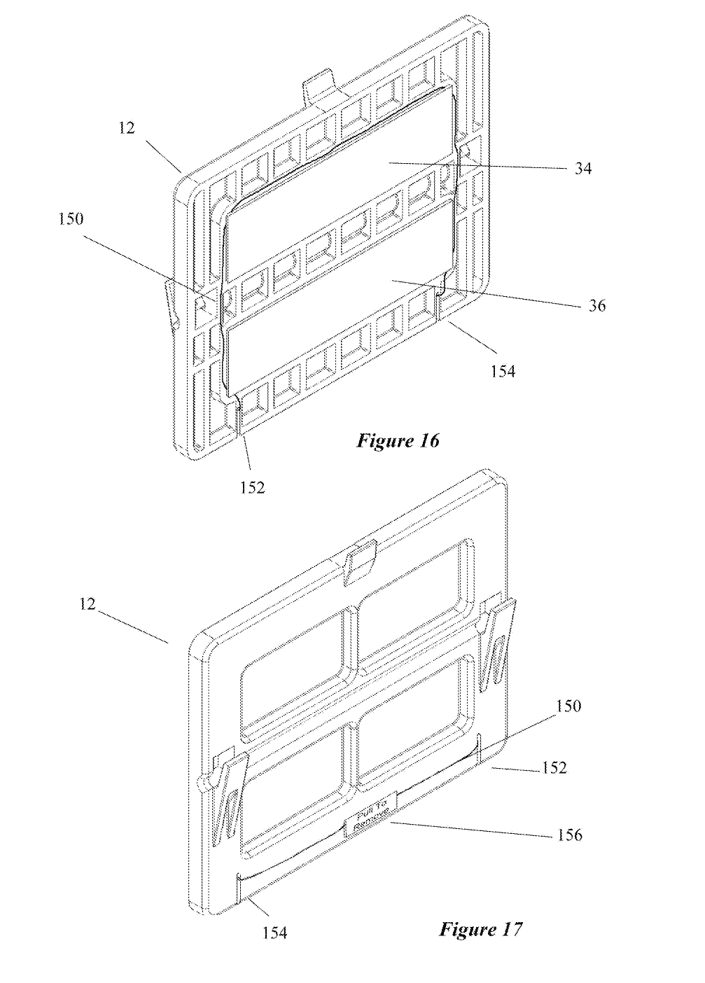

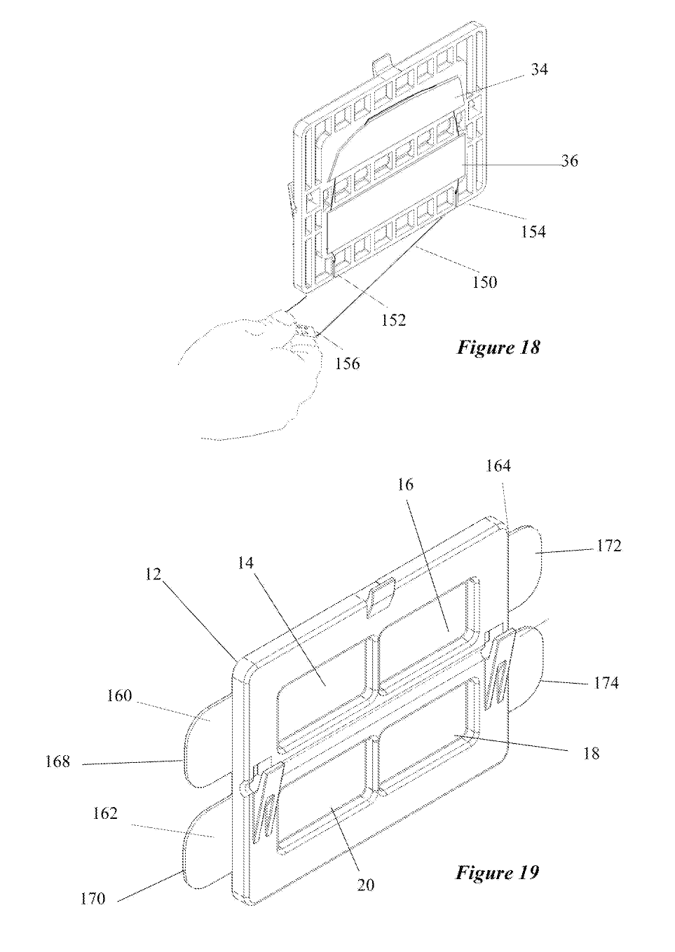

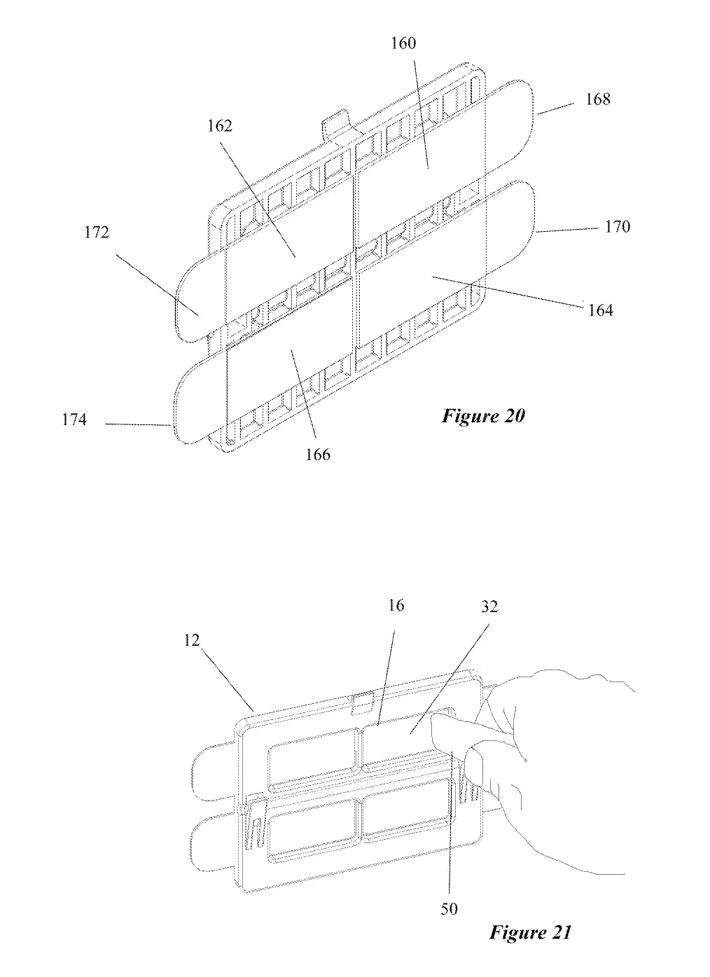

Another type of removable adhesive system as shown in FIGS. 16-18 uses a thread, much like dental floss, incorporated into the frame. A durable thread 150, such as nylon or dental floss, is mounted around the adhesive strips 34, 36 behind the corners of the adhesive strips. The thread passes through slots 152, 154 to the front side of the frame 12. The thread 150 is connected to tab 156. In use, the user merely pulls the tab 156, as shown in FIG. 16 which causes the thread to cut entirely through the foam layer of the adhesive strips except at the small corners of the adhesive strips. This cleanly separates the adhesive from the mounting surface. Any remaining residue can be easily cleaned by rubbing, applying heat or with common household cleaners. Any configuration can be used that allows a pre-mounted thread to be pulled to cut the foam tape layer.

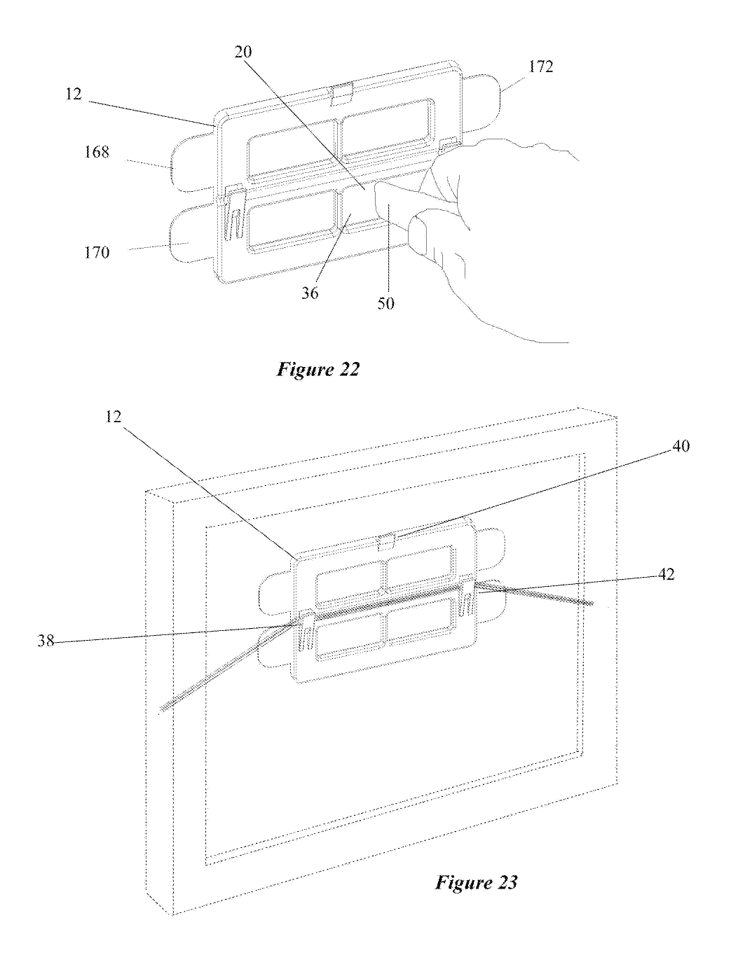

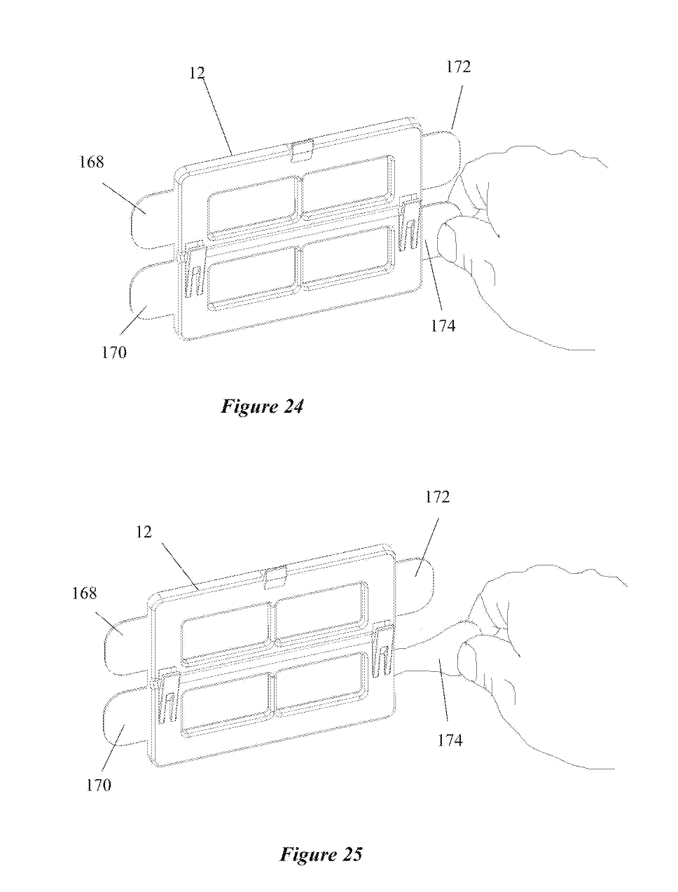

The system can also be easily removed from the mounting surface in one preferred embodiment. The Command adhesive system by 3M uses a releasable adhesive system. These adhesive strips are able to be used for mounting on most surfaces but are then able to be removed without significant damage to the mounting surface. The adhesive mounting strips 160, 162, 164, 166 as shown in FIGS. 19 and 21 are mounted onto the rear side of the bottom portions 14, 16, 18, 20 of frame 12. The adhesive mounting strips 160, 162, 164, 166 include tabs 168, 170, 172, 174, respectively, extending beyond the frame 12. These strips are securely mounted to the mounting surface as shown in FIGS. 21 and 22 with applicator 50. Once the fixture is to be removed, as shown in FIGS. 24 and 25, the user pulls on the tabs 168, 170, 172, 174. This causes the adhesive on the adhesive mounting strips to release from the mounting surface as the elastomeric adhesive base layer stretches and thins. Dental floss can also be used to separate the adhesive from the mounting surfaces. The hanger 10 is then removed from the mounting surface with minimal damage to the mounting surface. Other adhesive systems may be used as well including releasable adhesive systems and permanently mounted adhesive systems.

The claimed invention may also encompass a frame as described above with hook and loop fasteners. Either the hook or loop is pre-attached to the top surface of the frame. The counterpart hook or loop has adhesive applied to the back of it and is pre-installed onto the opposing hook or loop on the frame. The user then can use the adhesive applicator to apply increased pressure through the thinned portion of the frame and the hook and loop layers onto the adhesive layer that mounts to a surface. Once the frame has been attached to a mounting surface as described above, the hook and loop fasteners allow items to be repeatedly removed and remounted.

The frame 12 of the system 10 as described above provides a rigid framework with flexible portions. This not only allows the adhesive to be applied uniformly on uneven or angled surfaces but also spreads the load uniformly and evenly over the adhered surfaces. It is to be expressly understood that the claimed invention also encompasses other types of frames as well such as a completely rigid frame with no flexible portions.

Also, the system may use a completely flexible frame to allow mounting around corners, uneven surfaces, over objects, and on concave or convex surfaces. The flexible frame of this preferred embodiment may be a high strength film, fabric, or other flexible material. The back surface of this material may be coated with an adhesive material or have one or more adhesive strips affixed to it. The flexible material may be mounted around corners, within corners, over objects, such as conduits, cabling or other objects, into concave surfaces or over convex surfaces or any other shape. The applicator, such as applicator 50 then is used to apply magnified force on the flexible frame material to ensure that force is uniformly applied between the adhesive surface and the mounting surface as well as forcing the adhesive into all parts of the mounting surface.

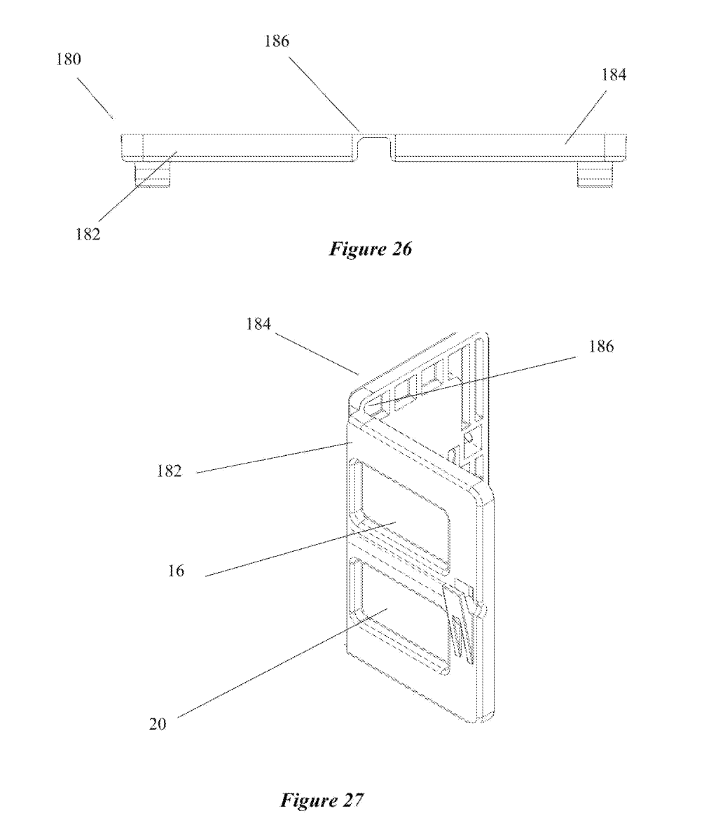

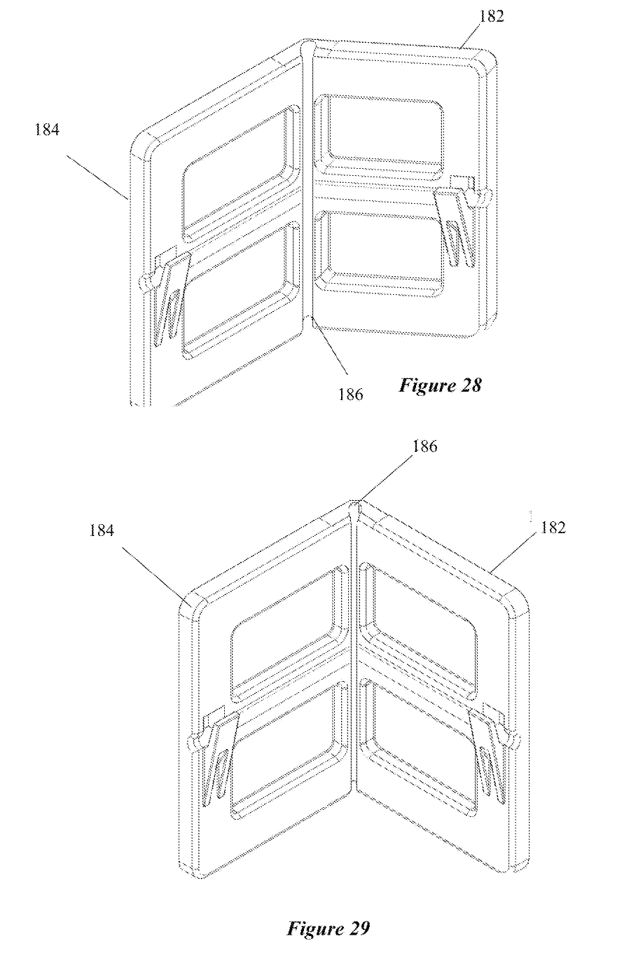

Another preferred embodiment of the present invention as shown in FIGS. 26-29 is a combination of a rigid frame with a flexible or hinged portion. One embodiment of this system is a rigid frame as described above that has components connected by living hinges or other flexible portions. As shown in FIG. 26, hinged frame 130 has components 182, 184 connected by living hinge 186. A living hinge is a hinge or flexure bearing with no moving parts. It is generally a thin section of the material that bends to allow movement. The components 182, 184 have recessed or thin areas that allow the applicator to provide pressure against for adhesion onto the mounting surfaces. The flexible or hinged portions allow the frame to be mounted around corners, over objects or on uneven surfaces. The frame can be flexed rearward as shown in FIG. 27, or flexed forward as shown in FIGS. 28 and 29. Adhesive mounting portions as discussed above may be affixed to either of the frame components. This allows a high load bearing system along with the ability to bend around corners or objects. The applicator will be used to ensure that force is uniformly applied on the adhesive surfaces against the mounting surfaces. Other mechanical means of flexing the frame can be used such as pin hinges or portions of another flexible material attached by other means. In addition, the frame can have any number of flexible elements at any angle or arrangement to allow adhesion to varied surfaces.

It is to be expressly understood that other embodiments are within the scope of the claimed invention. The above descriptions of preferred embodiments are provided for explanatory purposes and are not meant to limit the scope of the claimed invention.

1. A adhesive mounting system for mounting articles to a mounting surface, said adhesive mounting system comprises:
a frame for attachment to a mounting surface;
an adhesive on one surface of said frame; and
an applicator for applying force against said frame to increase the pressure on said adhesive against a mounting surface.

2. The adhesive mounting system of claim 1 wherein said applicator includes:
a body member; and
an end portion having a substantially thinner thickness than said body member for increasing the pressure against said frame.

3. The adhesive mounting system of claim 1 wherein said applicator includes:
a rolling member for applying force against said frame.

4. The adhesive mounting system of claim 1 wherein said frame includes:
a flexible portion onto which said adhesive is affixed for said applicator to apply pressure through said flexible portion.

5. The adhesive mounting system of claim 1 wherein said frame includes:
a rigid framework portion for spreading a load uniformly over said frame; and
a flexible portion onto which said adhesive is affixed for said applicator to apply pressure through said flexible portion.

6. The adhesive mounting system of claim 1 wherein said frame includes:
at least one recessed portion formed in said frame having said adhesive applied onto the bottom surface of each of said at least one recessed portion and for said applicator to engage in each of said at least one recessed portion to apply pressure against said bottom surface to force said adhesive against a mounting surface.

7. The adhesive mounting system of claim 1 wherein said frame includes:
a flexible portion onto which said adhesive is affixed so that said adhesive is forced onto contact with lower portions of uneven mounting surfaces.

8. The adhesive mounting system of claim 1 wherein said frame includes:
a rigid framework to ensure that a load attached to said rigid framework is spread uniformly over the surface onto which said adhesive has been applied.

9. The adhesive mounting system of claim 1 wherein said frame includes:
a flexible support surface onto which said adhesive is applied so that said frame can be mounted over surfaces that are not flat.

10. The adhesive mounting system of claim 1 wherein said system further includes:
a releasable adhesive so that said frame may be removed from the mounting surface with only minimal damage.

11. The adhesive mounting system of claim 1 wherein said system further includes:
a thread mounted to said frame that separates the adhesive from the mounting surface when said thread is pulled.

12. The adhesive mounting system of claim 1 wherein said system further includes:
a first component having a male member;
a second component having an interlocking female member for engagement with said male member;
a thinned area on one of said first component and said second component; and
an adhesive affixed to said thinned area for contact with the other of said first and second component when said first and second components are engaged together.

13. A adhesive mounting system for mounting articles to a mounting surface, said adhesive mounting system comprises:
a frame for attachment to a mounting surface;
an adhesive on one surface of said frame; and
an applicator having a body member and an end portion wherein said end portion has a substantially thinner thickness than said body member for increasing the pressure against said frame to force said adhesive onto a mounting surface.

14. The adhesive mounting system of claim 13 wherein said applicator includes:
a rolling member instead of said end portion for applying force against said thinned area.

15. The adhesive mounting system of claim 13 wherein said frame includes:
a flexible portion onto which said adhesive is affixed for said applicator to apply pressure through said flexible portion.

16. The adhesive mounting system of claim 13 wherein said frame includes:
a rigid framework portion for spreading a load uniformly over said frame; and
a flexible portion onto which said adhesive is affixed for said applicator to apply pressure through said flexible portion.

17. The adhesive mounting system of claim 13 wherein said frame includes:
at least one recessed portion formed in said frame having said adhesive applied onto the bottom surface of each of said at least one recessed portion and for said applicator to engage in each of said at least one recessed portion to apply pressure against said bottom surface to force said adhesive against a mounting surface.

18. The adhesive mounting system of claim 13 wherein said frame includes:
a flexible portion onto which said adhesive is affixed so that said adhesive is forced onto contact with lower portions of uneven mounting surfaces.

19. The adhesive mounting system of claim 13 wherein said frame includes:
a rigid framework to ensure that a load attached to said rigid framework is spread uniformly over the surface onto which said adhesive has been applied.

20. The adhesive mounting system of claim 13 wherein said frame includes:
a flexible support surface onto which said adhesive is applied so that said frame can be mounted over surfaces that are not flat.

21. The adhesive mounting system of claim 13 wherein said adhesive includes:
a releasable adhesive so that said frame may be removed from the mounting surface with only minimal damage to the mounting surface.

22. A method of adhesive mounting an object onto a mounting surface where said object includes a frame with an adhesive affixed to a surface on said frame and an applicator, said method comprising the steps of:
pressing the object onto the mounting surface so that the adhesive engages the mounting surface;
forcing the applicator against the frame of the object to apply pressure onto the adhesive against the mounting surface; and
moving the applicator along the frame to apply pressure uniformly onto the adhesive against the mounting surface.

23. The method of claim 22 wherein the method further comprises:
using an applicator that has a body member with an end portion where said end portion is substantially thinner than said body member to form a blunt knife edge.

24. The method of claim 22 wherein the frame includes:
a rigid framework to spread a load supported by the frame uniformly over the surface onto which the adhesive has been applied.

25. The method of claim 22 wherein the frame includes:
a flexible portion onto which the adhesive is affixed so that the adhesive is forced into uneven surfaces on the mounting surface when force is applied from the applicator.

26. The method of claim 22 wherein the adhesive includes:
a releasable adhesive so that the frame may be removed from the mounting surface with only minimal damage to the mounting surface.

27. A adhesive mounting system for mounting articles to a mounting surface, said adhesive mounting system comprises:
a frame for attachment to a mounting surface;
an adhesive on one surface of said frame; and
a thread mounted to said frame that separates the adhesive from the mounting surface when said thread is pulled.

28. The adhesive mounting system of claim 27 wherein said system further includes:
an applicator for applying force against said frame to increase the pressure on said adhesive against a mounting surface.

29. The adhesive mounting system of claim 27 wherein said applicator includes:
a rolling member for applying force against said frame.
